(19) United States
(12) Patent Application Publication
(10) Pub. No.: US 2007/0040030 A1
(43) Pub. Date: Feb. 22, 2007

(54) Contactless proximity communications apparatus and method

(75) Inventors: Arthur Kranzley, Pound Ridge, NY (US); Mark Lulic, Mohegan Lake, NY (US); John Wankmueller, Great Neck, NY (US)

Correspondence Address: Ryan, Mason & Lewis, LLP, Suite 205, 1300 Post Road, Fairfield, CT, 06824, US

(73) Assignee: MasterCard International Incorporated, Purchase, NY (US)

(21) Appl. No.: 11/499,098

(22) Filed: Aug. 4, 2006

Related U.S. Application Data
(60) Provisional application No. 60/708,686, filed on Aug. 16, 2005.

(51) Int. Cl. G06K 7/08; G06K 5/00; G06K 19/06

(52) U.S. Cl. 235/451; 235/492; 235/382

(57) ABSTRACT

Techniques for reducing or eliminating the likelihood of fraud in a contactless proximity communications apparatus are provided. The apparatus can include a body portion with a body, a communications circuit, and an antenna. The apparatus can also include a signal-disrupting portion that is mounted for motion, such as rotary or linear motion, with respect to the body portion and configured to substantially disrupt RF signals in a first position, and to move to a second position where RF communication is possible.

### CROSS-REFERENCE TO RELATED APPLICATION

This patent application claims the benefit of U.S. Provisional Patent Application Ser. No. 60/708,686 filed on Aug. 16, 2005, and entitled “Contactless Proximity Communications Apparatus and Method.” The disclosure of the aforementioned Provisional Patent Application Ser. No. 60/708,686 is expressly incorporated herein by reference in its entirety.

### FIELD OF THE INVENTION

The present invention generally relates to communications apparatus, and, more particularly, to a contactless proximity communications apparatus such as, for example, a contactless proximity payment card or other payment device.

### BACKGROUND OF THE INVENTION

Contactless proximity communications apparatus, such as cards and other kinds of payment devices, are exposed to a number of threats that do not typically arise in connection with magnetic strip or contact-based devices or cards. In contactless proximity devices or cards, wireless transfer of data occurs when an appropriate reader emanates a signal, such as a radio frequency (RF) signal, which the card or other device can use for power and subsequent processing. Unfortunately, contactless proximity devices, such as payment cards, may be amenable to interrogation by any reader that is able to communicate with them. This may not be a cause for great concern where an encrypted communications link is made use of, rendering captured data difficult or impossible to use. However, there are a number of applications that do not employ link encryption between the payment card or device and the RF reader.

A person contemplating fraud (“fraudster”) might place an RF reader in unexpected places that were not associated with credit or debit payments such as, for example, mass transit turnstiles, entrances to sports stadiums, underneath counters at the point of sale terminals of unsuspecting merchants, and the like. Furthermore, such a fraudster might employ an RF reader with stronger than usual RF signals, perhaps beyond those of the power levels that might be set by an applicable standard. Thus, a fraudster or other person bent on unauthorized activity might be able to initiate communication with an RF proximity card or device over distances longer than otherwise anticipated. Fraudsters could thus capture data from payment cards or devices at a distance, without the knowledge or consent of the account holder. An account holder would be unlikely to expect communication and/or interaction with a card or other device stored in his or her wallet, purse, or other location about the person. Such captured data could potentially be subsequently used for fraudulent transactions.

U.S. Pat. No. 6,121,544 to Petsinger discloses an electromagnetic shield to prevent surreptitious access to contactless smartcards. The Petsinger device provides shielding of contactless smartcards or RFID tags from electromagnetic radiation which imparts energy to power the contactless smartcards or RFID tags, thus preventing surreptitious, wireless exchanges of digital data with a remote transceiver. The electromagnetic shield is made of a soft magnetic alloy with a very high initial and maximum magnetic permeability, which has been fully hydrogen annealed to develop optimum magnetic shielding properties. In the preferred embodiment, this magnetic shielding material is sandwiched between two plastic reinforcing shells which allow very thin shielding materials to be used with little regard for their resistance to permanent deformation. The relatively high intrinsic electrical conductivity of the magnetic shielding material sufficiently simulates a Faraday cage to further shield a contactless smartcard/RFID tag from electric fields as well. The Petsinger device requires surrounding the card on both sides with a relatively expensive specialized magnetic alloy, and may require several manipulations of the card-shield system to enable use; for example, removing the shielded card from a wallet, then removing the card from the shield, possibly requiring both hands.

Accordingly, a need exists for a way to reduce and/or eliminate the possibility of unauthorized access to a contactless proximity communications apparatus, such as a payment card or device, using relatively common, inexpensive materials in a fashion that is convenient for the cardholder.

### SUMMARY OF THE INVENTION

Principles of the present invention provide techniques for a contactless proximity communications apparatus wherein signals can be disrupted under conditions when it is not specifically desired to use the apparatus. An exemplary embodiment of a contactless proximity communications apparatus, according to one aspect of the invention, includes a body portion and a signal-disrupting portion. The body portion can in turn include a body, a communications circuit associated with the body, and an antenna that is electrically coupled to the communications circuit. The signal disrupting portion can be mounted for motion (e.g., rotary motion, linear or sliding motion, or some combination thereof) with respect to the body portion, and can be configured to substantially disrupt RF signals associated with the antenna in a first position, and to permit substantially unimpeded passage of the RF signals associated with the antenna in a second position. The signal-disrupting portion can be formed from a material exhibiting low magnetic permeability, e.g., a metal foil such as aluminum or copper on a plastic substrate. The signals associated with the antenna could be, for example, signals being transmitted to the antenna by an RF reader. The first position could correspond to transport or storage, while the second position could correspond to conditions where it is deliberately desired to communicate with a reader. The antenna can have first and second major sides, and in one or more embodiments, the signal-disrupting portion need be adjacent only a single one of the major sides of the antenna (preferably, substantially covering same). As used herein, “RF” signals are intended to encompass any electromagnetic radiation currently or hereafter used with the types of contactless devices described herein (currently from about on the order of 100 kHz to about on the order of several hundred GHz).

In another aspect of the invention, an exemplary kit of parts can include an appropriate signal-disrupting structure and a mounting portion designed to be secured to the structure and a payment device such as a payment card.

An exemplary method of reducing the likelihood of unauthorized access to a proximity communications apparatus, in accordance with another aspect of the invention, includes the steps of maintaining the apparatus in a first state and then transitioning the apparatus to a second state. In the first state, a signal-disrupting structure is positioned to substantially disrupt RF communication with the apparatus. In the second state, where RF communication is desired, the signal-disrupting structure is moved such that RF communication can proceed in a substantially unimpeded manner. The signal-disrupting structure can be as described above.

In still another aspect of the invention, the motion between the body portion and the signal-disrupting portion can be rotary, and the body portion can be formed with a keyhole-shaped aperture wherein a hinge can be snapped for mounting purposes.

In yet a further aspect of the invention, the signal disrupting structure can simply comprise a separate conductive portion, for example, a substrate with a foil, which is configured and dimensioned to be collocated in a wallet with the device it is desired to shield.

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1 shows an exemplary embodiment of contactless proximity payment card apparatus, with a hinged signal-disrupting portion, in accordance with an aspect of the invention;

FIG. 2 shows a card portion of the card apparatus of FIG. 1;

FIG. 3 shows a reverse portion of the card portion of FIG. 2;

FIG. 4 shows a view of the card apparatus of FIG. 1 in a closed condition;

FIG. 5 is a cross-sectional view taken along line V-V of FIG. 4, with the thickness exaggerated for clarity;

FIG. 6 is a cross-sectional view taken along the line VI-VI of FIG. 4, again with the thickness exaggerated for clarity;

FIG. 7 is an alternative embodiment of a payment card apparatus in accordance with another aspect of the present invention;

FIG. 8 is a view of the device of FIG. 7 without a card portion in place;

FIG. 9 is a view of the apparatus of FIG. 7 with the card portion swung to an open position;

FIG. 10 shows an exemplary embodiment of contactless proximity payment card apparatus, with a sliding signal-disrupting portion, in accordance with another aspect of the invention;

FIG. 11 is a side view, with the thickness exaggerated for clarity, of the apparatus of FIG. 10;

FIG. 12 is a view of the apparatus of FIG. 10 with the sliding portion set to a shielding configuration;

FIG. 13 is a view similar to FIG. 10 but of an alternative form of payment card apparatus with a different type of sliding portion, in accordance with yet another aspect of the invention;

FIG. 14 is a side view, with the thickness exaggerated for clarity, of the apparatus of FIG. 13;

FIG. 15 is a perspective view of an exemplary embodiment of a separate signal-disrupting structure for collocation with a card or other device in a wallet or the like, according to yet another aspect of the invention;

FIG. 16 is a cross-sectional view, with the thickness exaggerated for clarity, taken along lines XVI-XVI in FIG. 15;

FIG. 17 depicts an exemplary alternative hinge configuration for an embodiment with substantially rotary motion between the signal-disrupting structure and card or other device;

FIG. 18 is a flow chart depicting method steps of an exemplary embodiment of a method of reducing the likelihood of unauthorized access to a payment device, according to an aspect of the invention; and

FIG. 19 is a system block diagram of a computer system having applicability to one or more elements of one or more embodiments of the invention.

### DETAILED DESCRIPTION OF PREFERRED EMBODIMENTS

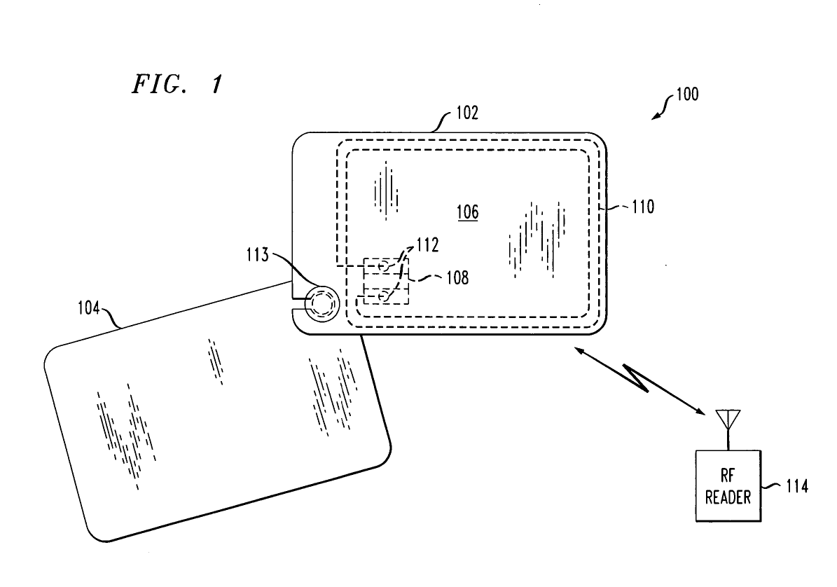

Attention should now be given to FIG. 1, which depicts an exemplary embodiment of a contactless proximity communications apparatus 100 in accordance with an aspect of the present invention. Apparatus 100 includes a body portion 102 and a signal-disrupting portion 104. Portion 102 in turn includes a body 106, a communications circuit 108 associated with the body, and an antenna 110 electrically coupled to the communications circuit 108. The communications circuit 108 can be any of a number of well-known RF integrated circuit chips. Antenna 110 can, as shown, include a number of windings located about the periphery of body 106 and electrically interconnected with appropriate contact regions 112 of circuit 108. While the present invention can be employed with any type of RF communications device (even powered devices, if desired), the exemplary embodiment shown in FIG. 1 envisions an inductively coupled device wherein the communications circuit 108 is in the form of a passive transponder. It should be understood that variations from the configuration shown are possible; for example, the antenna could be formed on the circuit 108, or could extend over only a portion of the card, for example, over part of the periphery of the card.

Signal-disrupting portion 104 can be mounted for motion with respect to the antenna 110 (and in the embodiment shown, with respect to the body portion 106 since the antenna is fixed to it). In the exemplary embodiment depicted, the motion is substantially rotary, but it will be appreciated that substantially sliding or linear motion, or other types of motion, for example, a combination of rotation and translation, are possible. The mounting of the signal-disrupting portion 104 for substantially rotary motion with respect to the body portion 106 and antenna 110 can be, for example, by a hinge 113 to be discussed more fully below. Portion 104 can be configured to substantially disrupt RF signals associated with the antenna 110 in a first position, to be discussed below. Further, signal-disrupting portion 104 can be configured to permit substantially unimpeded passage of the RF signals associated with the antenna 110 in a second position, as shown in FIG. 1. By indicating that RF signals are “associated with” the antenna 110, what is meant is that the signals are transmitted to or from antenna 110, for example, from or to RF reader 114. Substantial disruption of the RF signals should be broadly understood to include any one or more of interference, reflection, blocking, capacitive coupling phenomena, attenuation, distortion, field interaction, and any other type of RF, electromagnetic, or other phenomenon that will sufficiently degrade potential interrogation of apparatus 100 by a fraudster, so as to reduce or eliminate the possibility of a fraudster gaining unauthorized access to data in circuit 108.

In the exemplary embodiment shown in FIG. 1, the apparatus is the form of a contactless proximity payment card apparatus. Body 106 is a card structure, and has a peripheral portion in which the aforementioned antenna 110 is located; antenna 110 is formed as a coil about the peripheral portion. Signal-disrupting portion 104 should be at least partially formed from a conductive material, such as a metallic material. This could include foil, solid metal, embedded metal elements, and the like. In the exemplary embodiment shown in FIG. 1, signal-disrupting portion 104 is itself in the form of a card. It can be covered on at least one side with, for example, aluminum foil, to perform the signal-disrupting function. The aluminum foil can be mounted to a substrate portion of the card as discussed below. Of course copper or other suitable foils could also be used. Note that the foil on portion 104 does not overlap the coils of antenna 110 in the open position depicted in FIG. 1. It has been found that ordinary household aluminum foil works well. The foil can be mounted, for example, on a piece of plastic having the size, shape, and thickness of a card conforming to ISO 7810 ID-1, particularly when such a card is to be protected from unwanted interrogation (again, this is purely exemplary and not intended to be limiting, as other sizes and form factors can be employed as appropriate). The RF card or device to be protected can conform, for example, to ISO 14443 type A or B.

In one or more embodiments, the signal-disrupting portion is formed from a material exhibiting low magnetic permeability. Aluminum and copper are examples of such materials. “Low magnetic permeability” is intended to refer to materials having a magnetic permeability similar to that of free space. Low magnetic permeability materials may include small or trace amounts of other materials that are not in themselves low magnetic permeability materials, as long as the resulting composition exhibits low magnetic permeability overall. The skilled artisan will appreciate that diamagnetic and paramagnetic materials typically exhibit such low magnetic permeability, while ferromagnetic, ferrimagnetic, and antiferromagnetic materials typically do not (Group 8B metals such as Fe, Co, and Ni may generally be considered as high permeability materials). Such properties are discussed in well-known reference books such as in Chapter 2 of N. N. Rao's “Elements of Engineering Electromagnetics” (4th ed.) as published by Prentice Hall in Englewood Cliffs, N.J., USA in 1994, or in Chapter 36 of R. C. Dorf (editor), “The Electrical Engineering Handbook” (2nd ed.) as published by the CRC Press in Boca Raton, Fl., USA in 1997.

In one or more embodiments, the signal-disrupting portion is generally planar, the antenna 110 has first and second major sides (e.g., the major sides of the body 106 in which it is formed), and the signal-disrupting portion is substantially adjacent only a single one of the major sides of the antenna when in the first (blocking) position. Preferably, the signal-disrupting portion substantially covers the single side of the antenna to which it is adjacent. The low magnetic permeability material feature and the single-sided feature can be employed separately, or preferably together, thus facilitating a relatively thin, inexpensive shielding structure, which may also allow for easy transitioning between blocking and communicating positions.

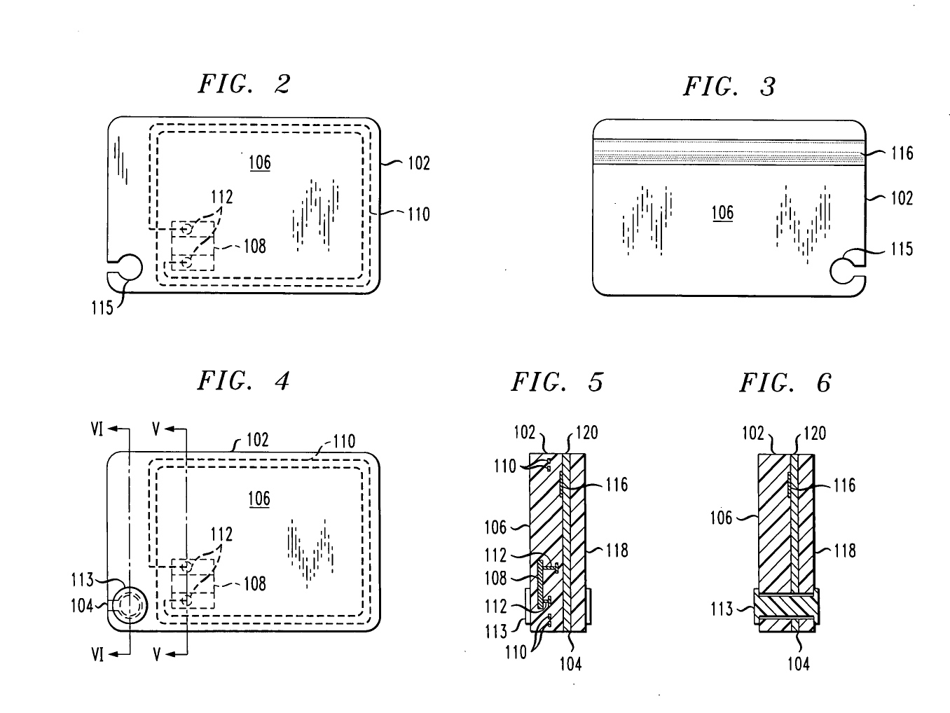

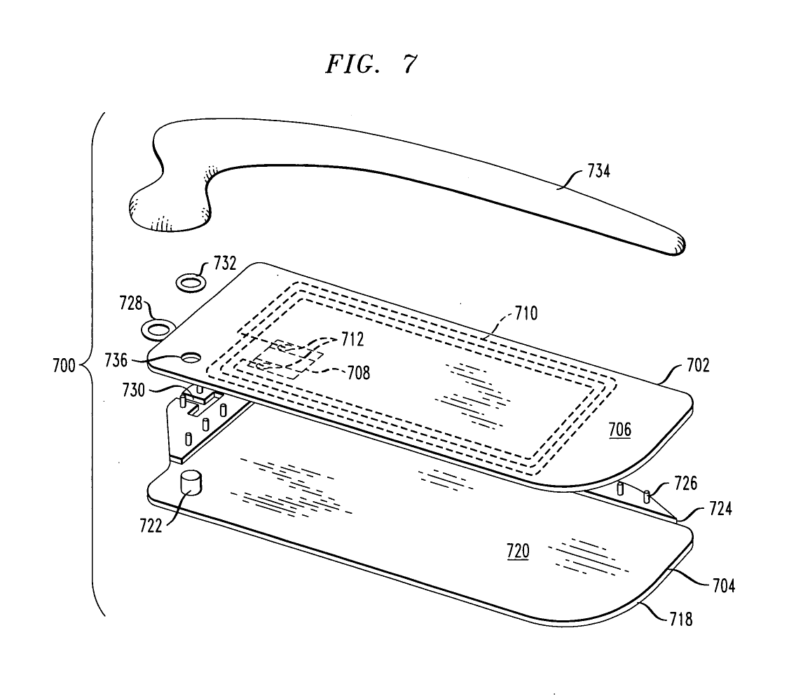

Attention should now be given to FIG. 2, which shows further details of the body portion of the apparatus of FIG. 1. As shown in FIG. 2, body portion 106 can be formed with a keyhole-shaped hole region 115 in a lower left hand corner thereof. Keyhole-shaped hole region 115 can be adapted to releaseably retain the aforementioned hinge. Thus, if desired, the body portion can be detachable from the signal-disrupting portion by, for example, “snapping” the hinge in and out of the keyhole-shaped region 115. This can be accomplished by making the lower diameter portion of the hinge, best seen in FIGS. 5 and 6 described below, very slightly larger in diameter than the narrow part of the keyhole, but slightly less than the diameter of the hole at the end of the narrow portion of the keyhole. Of course, other locations are possible for the keyhole-shaped region.

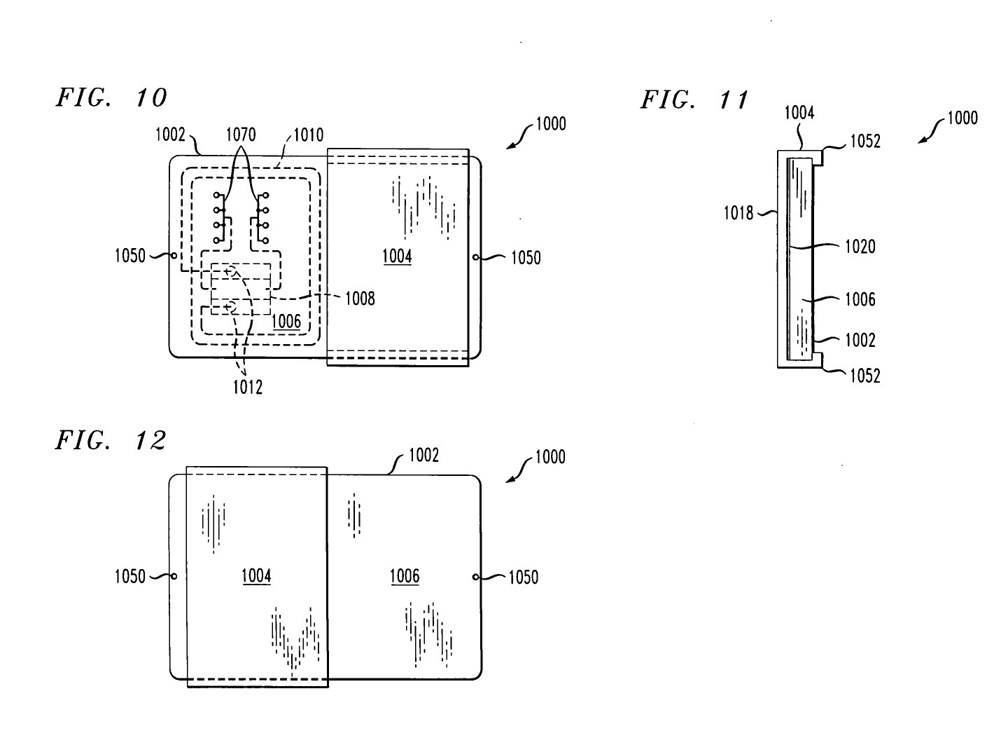

Giving attention now to FIG. 3, a rear portion of the body portion 102 is shown. The communications circuit and antenna are omitted for clarity. Body portion 102 includes a contact-readable portion 116 located for example, at an upper rear portion. Contact-readable portion 116 can be, for example, a magnetic strip. Alternatively, the contact readable portion could be the contacts of a contacted smart card; see discussion of FIG. 10 below. It will be appreciated that when signal-disrupting portion 104 is in an “open” position as shown in FIG. 1, contact-readable portion 116 would be readily accessible to a contact-reading device so that the card could be “swiped” (or placed in contact with the contacts of a contacted-card reader).

Attention should now be given to FIG. 4, which shows a front view of the apparatus of FIG. 1 with the hinged signal-blocking device 104 in a “closed” position. It will be appreciated that the hinged signal blocking device could function as a handle in the position shown in FIG. 1, and also can serve as a visual indicator of whether the apparatus is enabled for RF communication as in FIG. 1, or is in a “blocked” state as in FIG. 4 (this is also true of the other exemplary signal blocking devices described below). It will also be appreciated that in the first position, as shown in FIG. 4, the signal-disrupting portion 104 is substantially coextensive with the body 106 of body portion 102. Still with reference to FIG. 4, attention should now also be given to FIGS. 5 and 6, which are cross-sectional views along, respectively, lines V-V and VI-VI of FIG. 4. As shown in FIGS. 5 and 6, signal-disrupting portion 104 can include a substrate 118 with a metallic foil 120 associated therewith (e.g., glued or bonded thereto, laminated thereto, deposited thereon, and the like). Only two windings are depicted for antenna 110 for purposes of illustrative convenience; a sufficient number of windings should of course be used for the application contemplated. Further, circuit 108 and the windings of antenna 110 are shown as being embedded in body 106. However, any suitable type of construction can be employed; for example, the body portion 106 could be formed of one or more laminates containing the circuit 108 and the windings of antenna 110. Hinge 113 is shown in unitary form with a flanged portion at either end. Hinge 113 could, if desired, be fabricated from several different pieces to permit ready assembly. Further, if desired, signal-disrupting portion 104 could also be formed with a keyhole-shaped region instead of an ordinary through hole as shown in the drawings.

Attention should now be given to FIG. 7, which depicts an alternative form of proximity payment card device 700 in accordance with another aspect of the present invention. Items similar to those shown in FIGS. 1-6 have received the same reference character incremented by 600. Body portion 702 can (if desired) be formed with a body 706 that is, for example, smaller and/or of a different shape and/or aspect ratio than a conventional payment card. The signal-blocking portion 704 can be formed as a backing plate. An RF circuit 708, antenna 710 and contacts 712 can be provided as before. The backing plate can include a substrate 718 with a foil 720 secured thereto on a top surface. A projecting pin 722 can be provided. A raised peripheral region 724 can include a number of small pins 726 which can engage with holes, not shown, formed in retaining snap 734. A suitable ring 728 can be provided that allows the apparatus 700 to be fastened, for example, to a keychain; a region 730 can be formed in backing 704 to receive the ring 728. A retaining “doughnut” 732 can be provided to engage with projecting pin 722 and retaining snap 734. A suitable hole, such as, for example, a conventional hole 736 can be formed in body 706 (a keyhole-shaped region can instead be provided, if desired).

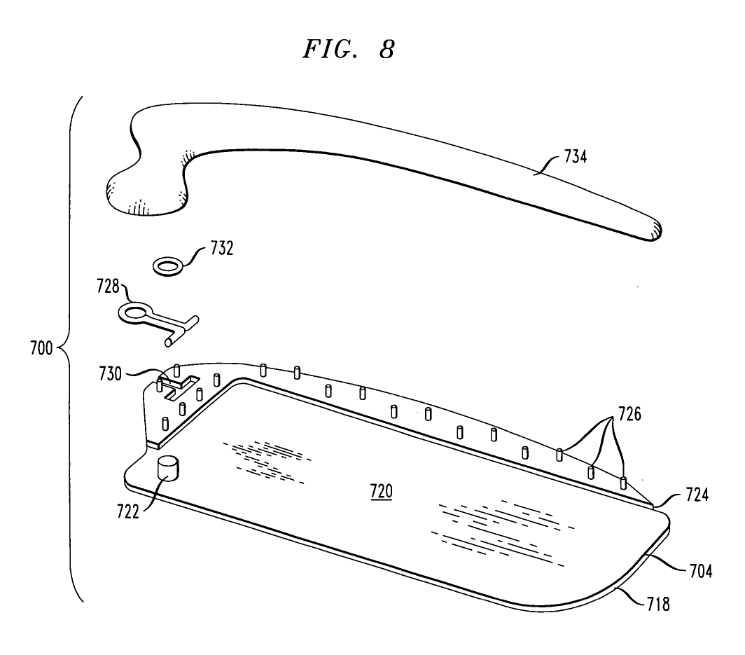

FIG. 8 shows the same apparatus as FIG. 7, with the body 702 omitted for purposes of illustrative clarity. Note that the foil 720 may extend over all or only a portion of substrate 718. Of course, the foil 720 must have a sufficient extent to perform the signal-blocking function. At present, it is believed that signal-blocking requires the foil to substantially cover the antenna coils in the closed position. As used herein, “substantially” is intended to cover exact correspondence or approximate correspondence resulting in an operative configuration.

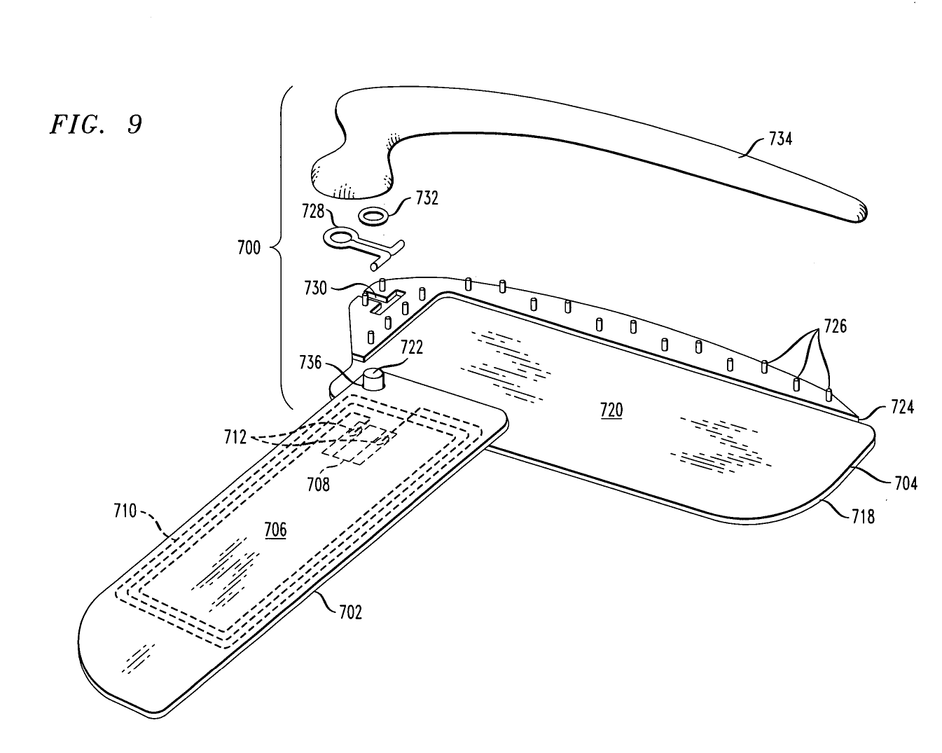

FIG. 9 shows the apparatus of FIGS. 7 and 8 and with body portion 702 in an “open” position. It will be appreciated that body portion 702 can be rotated further to have even less overlap of the coils of antenna 710 with the foil 720; alternatively, as noted above, the foil 720 need not extend over the entire surface of substrate 718. Further, the windings of antenna 710 could be recessed further from the edge of the body 706 of body portion 702 as shown for other exemplary embodiments in FIGS. 10-14, discussed below. Appropriate testing can be done to ensure that RF communication can proceed in an “open” condition, but that potential signals from a fraudster can be substantially blocked in the closed position shown in FIG. 7. At present it is believed that the foil should substantially cover the antenna in the closed position and preferably should substantially not overlap the coils in the open position.

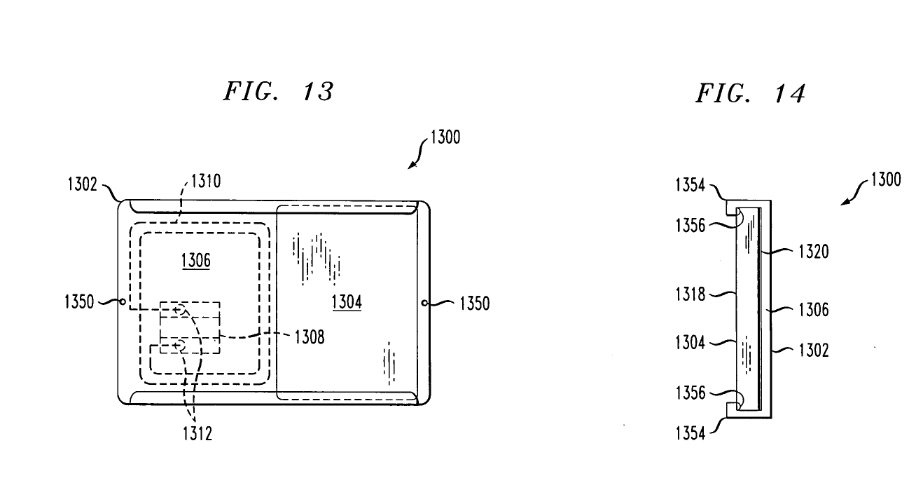

Attention should now be given to FIGS. 10-12, which show an alternative embodiment of the invention with a sliding (substantially linear motion) signal-disrupting portion. Elements analogous to those in FIGS. 1-6 will receive the same reference character incremented by nine hundred, and will be discussed only to the extent they differ substantially from those in the earlier figures. Signal-disrupting portion 1004 includes a track for mounting portion 1004 to body 1006 of body portion 1002, for substantially linear relative motion between portion 1004 and antenna 1010. The track can be formed from channel-like extensions 1052 on portion 1004. Antenna 110, body portion 1002, and portion 1004 each have a planform area, i.e., an area when viewed from a point perpendicular to the plane of the paper in FIG. 10. In the case of the antenna, the planform area can be thought of as the area enclosed by the outermost coils. The planform area of the antenna 1010 is no more than about half that of the body portion 1002. The planform area of the signal-disrupting portion 1004 is at least substantially the same as that of the antenna. This permits portion 1004 to slide from an open position in FIG. 10 where the coils of antenna 1010 are not blocked, to a closed position in FIG. 12 where the coils of antenna 1010 are blocked. Portion 1004 can be retained, for example, by small projections 1050. Portion 1004 can be formed, for example, from a plastic substrate 1018 with molded channel-like regions 1052, and a foil portion 1020. Contacts 1070 for a contacted smartcard interface can also be provided, and are accessible in the position of FIG. 10 and concealed in the position of FIG. 12.

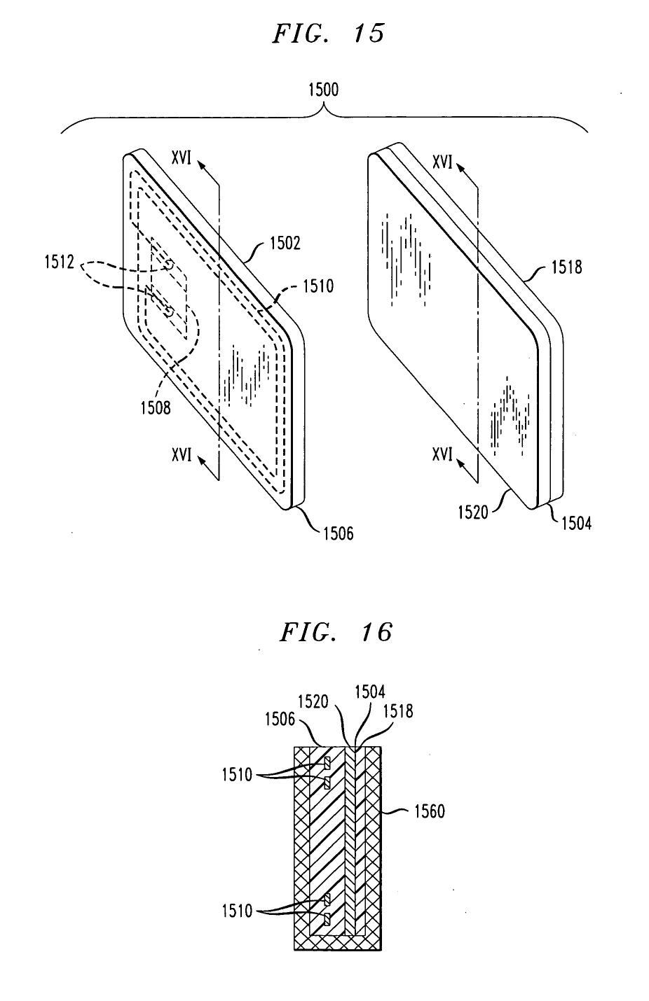

FIGS. 13 and 14 show an exemplary embodiment similar to that of FIGS. 10-12, except that the track is formed on the body portion 1306 by channel-like projections 1354. Note that elements similar to FIGS. 10-12 have received the same reference character, incremented by three hundred. Track-engaging portions 1356 can be formed on structure 1304, and could simply be the ordinary surface of structure 1304, or a friction material such as felt, rubber, and the like. Note that projections 1050, 1350 are omitted from end views (FIGS. 11 and 14) for illustrative convenience. Note also that the configuration of FIGS. 10-12 may be preferable as that of FIGS. 13 and 14 may require substantial modification to existing cards or other payment devices.

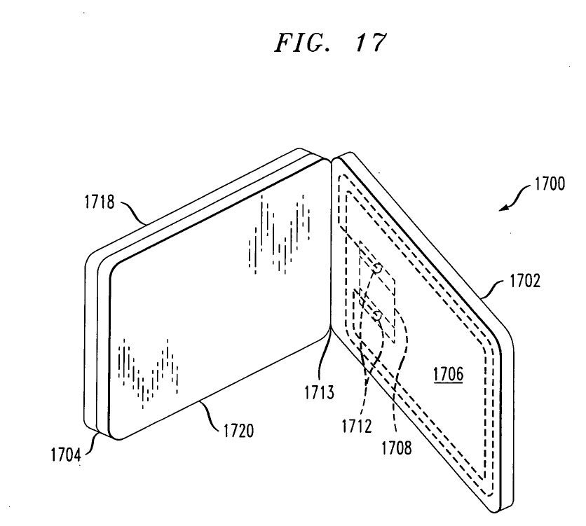

FIGS. 15 and 16 show yet another alternative approach. Elements similar to those in FIGS. 1-6 have received the same reference character, incremented by fourteen hundred, and will be described only to the extent they differ substantially from the earlier embodiment. Signal-disrupting portion 1504 is collocated with a device such as card 1502 in a wallet 1560 (broadly understood to include any personal article that can retain card 1502 adjacent portion 1504 to reduce the likelihood of fraudulent interrogation and be easily carried on the person). When it is desired to allow communication, card 1502 is removed from wallet 1560 in an otherwise conventional manner and is ready for communication. It can then be simply replaced next to portion 1504 when done. Portion 1504 can, if desired, be secured temporarily or permanently in wallet 1560 via friction, adhesive, and the like. Note that for purposes of illustrative convenience, the wallet is depicted in FIG. 16 only. Thus, FIGS. 15 and 16 depict an inventive system.

In another aspect of the invention, a kit of parts can be provided. For example, the kit of parts could include a signal-disrupting structure of any of the kinds described herein. A mounting portion of any of the kinds described can also be provided. For example, the mounting portion could be a hinge portion that is securable to the signal-disrupting structure. As used in this context, “securable” could include permanent or removable attachment, including integral forming with the signal-disrupting structure. A mounting structure such as that described for sliding motion could also be used. Such structure and mounting portion could be distributed, for example, to people already having contactless proximity communications apparatus, such as contactless RF payment cards, in their possession. If desired, an instruction sheet could be included with the kit of parts, and could include instructions for assembling the signal-disrupting structure to the payment card with the mounting portion, such that the signal-disrupting structure would be mounted for motion with respect to the payment card upon assembly. The signal-disrupting structure would then be configured to substantially disrupt the RF signals when it was in a first position relative to the antenna, and to permit substantially unimpeded passage of the RF signals when it was in a second position relative to the antenna. Alternatively, the kit of parts could also include the card or other device, which could be of the type described herein, including a body defining a hinge-receiving aperture or the other mounting schemes described. Various types of hinge constructions could be employed, depending on whether the cards which they were to be used with had a keyhole-shaped hole, or an ordinary through hole, as in the various embodiments described herein. A clamp or fiction fit structure could even be provided to receive cards not having apertures therein. Such clamp or friction structure could be attached to the hinge which could also be attached to the signal-disrupting portion, such that rotary motion would be possible. A kit of parts based on the embodiment of FIGS. 15 and 16, e.g., could include the structure 1504, instructions for how to collocate it in the wallet 1560 with card 1502, and instructions for how to remove it when communication was desired (a wallet could also be included if desired). Thus, the kit of parts could include, for example, any or all of the elements described herein, with suitable instructions for operation as outlined herein.

FIG. 17 shows yet another alternative exemplary embodiment of the invention. Items similar to those in FIGS. 1-6 have received the same reference character, incremented by sixteen hundred, and will not be discussed except to the extent that they differ substantially from the above-described embodiment. Portion 1704 is configured for substantially rotary motion with respect to body portion 1702, about an axis of rotation in the plane of body portion 1702, instead of an axis perpendicular to it as in the above exemplary embodiments. Hinge 1713 is formed along a common edge of potion 1704 and body 1706. The common edge could be a short edge as shown, or could be a long edge. The short edge configuration shown might be preferable for insertion of the card into a machine such an automated teller machine (ATM) along the long dimension of the card. Any suitable hinge can be used, for example, a “living” hinge formed by the plastic body 1706 and substrate 1718.

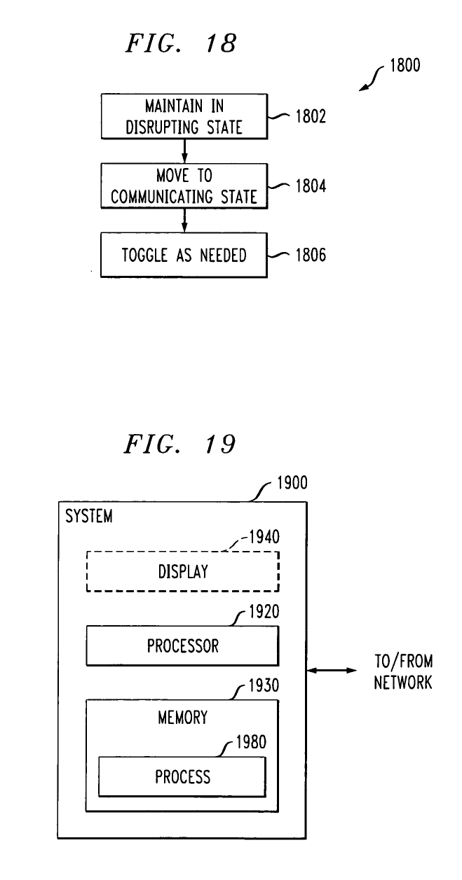

Turning now to FIG. 18, a flow chart 1800 depicts exemplary method steps for reducing the likelihood of unauthorized access to a proximity communications apparatus while permitting appropriate access, in accordance with an aspect of the present invention. As indicated in block 1802, the apparatus can be maintained in a first state wherein a signal-disrupting structure is positioned to substantially disrupt RF communication with the apparatus. In block 1804, the apparatus can be transitioned to a second state where RF communication is desired. Thus, the signal-disrupting apparatus can be moved, into the second state, such that RF communication can proceed in a substantially unimpeded manner. Finally, at block 1806, one can toggle back and forth between the two states as needed. For example, the apparatus could normally be maintained in the first, or disrupting, state when being carried in a wallet or purse under normal circumstances. The apparatus could be toggled to the second state when in proximity to a reader which it was desired to communicate with, and once the reading had occurred, could then be returned to the first state in the wallet or purse. The method can be applied, e.g., to any of the exemplary embodiments depicted herein. The toggling can constitute sliding, rotating, removing from a wallet or replacing therein, and the like.

It will be appreciated that the different embodiments of apparatus and method described above are exemplary in nature, and various modifications can be made thereto. For example, any of the hinge portions can be permanently attached or removable or formed integrally with the card or the signal-disrupting portion. Various shapes can be employed for the signal-disrupting portion (any configuration which adequately disrupts the signals to reduce or eliminate the chance of fraud). It will be further appreciated that the location of the hinge at the lower left hand corner as depicted in the various figures, with the magnetic strip at the upper rear portion of the card, is advantageous in that it allows the card to be swiped at a standard magnetic strip reader when in the open position (of course, the hinge could have been located in the lower right-hand corner, or elsewhere, instead). Further, note that detachability of the signal-disrupting portion from the card is desirable such that the card can be inserted completely into certain apparatuses, such as ATMs, which require the entire card to be inserted. The foil can be on the side of the substrate facing the card or device or on the other side (depending on the thickness of the card or other device; either orientation has been found to work for standard thickness payment cards or devices). Note that the card or device may have a limit to how thick it can be before the one-sided blocking action no longer works. The RF devices can be cards of any form factor (not necessarily standard debit or credit cards) and need not be cards at all; other payment devices such as appropriately configured personal digital assistants (PDAs) or cellular phone handsets could be employed. The signal-disrupting portions can have form factors similar to or different from the cards of other devices.

The invention can employ hardware and/or software aspects. Software includes but is not limited to firmware, resident software, microcode, etc. Software might be employed, for example, in connection with a reader 114. . Firmware might be employed, for example, in connection with a communications circuit 108, 708, 1008, 1308, 1508, 1708. FIG. 17 is a block diagram of a system 1700 that can implement part or all of one or more aspects or processes of the present invention. As shown in FIG. 17, memory 1730 configures the processor 1720 to implement one or more aspects of the methods, steps, and functions disclosed herein (collectively, shown as process 1780 in FIG. 17). The memory 1730 could be distributed or local and the processor 1720 could be distributed or singular. The memory 1730 could be implemented as an electrical, magnetic or optical memory, or any combination of these or other types of storage devices. It should be noted that each distributed processor that makes up processor 1720 generally contains its own addressable memory space. It should also be noted that some or all of computer system 1700 can be incorporated into an application-specific or general-use integrated circuit. Reader 114 could be equipped with suitable processing and software capability to remind users to unshield devices when it was desired to communicate with the reader. Sensors (e.g., weight, motion) could detect the presence of an individual whose card was protected from RF interrogation.

System and Article of Manufacture Details

As is known in the art, part or all of one or more aspects of the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Thus, elements of one or more embodiments of the present invention, such as, for example, the aforementioned reader 114 or communications circuits 108, 708, 1008, 1308, 1508, 1708 can make use of computer technology with appropriate instructions to implement method steps described herein. By way of further example, a reader apparatus 114 could include a communications module, an antenna coupled to the communications module, a memory, and at least one processor coupled to the memory and the communications module and operative to interrogate a contactless payment device.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A contactless proximity communication apparatus comprising:
a body portion, said body portion in turn comprising:
a body;
a communications circuit associated with said body; and
an antenna electrically coupled to said communications circuit; and
a signal-disrupting portion mounted for motion with respect to said antenna, said signal-disrupting portion being configured to substantially disrupt RF signals associated with said antenna in a first position and to permit substantially unimpeded passage of the RF signals associated with said antenna in a second position, said signal-disrupting portion being formed from a material exhibiting low magnetic permeability.

2. The apparatus of claim 1, wherein said signal disrupting portion is generally planar, said antenna has first and second major sides, and said signal disrupting portion is substantially adjacent only a single one of said first and second major sides of said antenna in said first position.

3. The apparatus of claim 2, wherein said signal disrupting portion substantially covers said single one of said first and second major sides of said antenna in said first position.

4. The apparatus of claim 3, wherein said signal-disrupting portion is at least partially formed from a conductive material.

5. The apparatus of claim 4, wherein said conductive material is metallic.

6. The apparatus of claim 4, wherein:
said body is in the form of a card having a peripheral portion;
said antenna comprises a coil formed substantially about said peripheral portion; and
said circuit comprises a passive transponder.

7. The apparatus of claim 3, wherein said motion is substantially rotary motion, further comprising a hinge, said hinge mounting said signal-disrupting portion for said substantially rotary motion with respect to said antenna.

8. The apparatus of claim 7, wherein said body is in the form of a card, said card defining a keyhole-shaped region adapted for releasable retention of said hinge.

9. The apparatus of claim 3, wherein said body portion further comprises a contact- readable portion and said signal-disrupting portion is configured to permit substantially free access to said contact-readable portion in at least said second position.

10. The apparatus of claim 3, wherein said signal-disrupting portion is configured to function as:
a handle in at least one of said first and second positions; and
a visual indicator of whether said apparatus is presently enabled for RF communication.

11. The apparatus of claim 3, wherein said body portion is in the form of a card and said signal-disrupting portion is also in the form of a card, said signal disrupting portion being substantially coextensive with said first portion in said first position.

12. The apparatus of claim 11, wherein said signal disrupting portion comprises a substrate and a metallic foil associated with said substrate.

13. The apparatus of claim 3, wherein said motion is substantially linear motion, further comprising a track formed on one of said body portion and said signal-disrupting portion, said track mounting said signal-disrupting portion for said substantially linear motion with respect to said antenna.

14. The apparatus of claim 13, wherein said track is formed on said signal-disrupting portion, said track comprising channel-like extensions for receiving said body portion.

15. The apparatus of claim 13, wherein said body portion, said antenna, and said signal-disrupting portion each have a planform area, said planform area of said antenna is no more than about one-half of said planform area of said body portion, and said planform area of said signal-disrupting portion is at least substantially the same as that of said antenna.

16. A kit of parts comprising:
a signal-disrupting structure having a conductive portion adapted to substantially disrupt radio frequency (RF) signals, said signal-disrupting portion being formed from a material exhibiting low magnetic permeability; and
a mounting portion securable to said signal-disrupting structure.

17. The kit of parts of claim 16, adapted for use with an RF payment card comprising an antenna having first and second major sides, further comprising an instruction sheet providing instructions for assembling said signal-disrupting structure to the payment card with said mounting portion such that said signal-disrupting structure will be mounted for motion with respect to the payment card upon assembly thereto, said signal-disrupting structure being configured to substantially disrupt the RF signals in a first position relative to the antenna and to permit substantially unimpeded passage of the RF signals in a second position relative to the antenna.

18. The kit of parts of claim 17, wherein said signal disrupting structure is configured to be substantially adjacent only a single one of said first and second major sides of said antenna in said first position.

19. The kit of parts of claim 18, wherein said signal disrupting structure is configured to substantially cover said single one of said first and second major sides of said antenna in said first position.

20. The kit of parts of claim 19, wherein said motion is substantially rotary, further comprising the RF payment card with the antenna having the first and second major sides, wherein said mounting portion comprises a hinge.

21. The kit of parts of claim 19, wherein said motion is substantially linear, further comprising the RF payment card with the antenna having the first and second major sides, wherein said mounting portion comprises one of:
a track formed on said signal-disrupting structure for receipt of said card; and
a track-engaging portion formed on said signal-disrupting structure so as to engage a track of said card;
said mounting portion mounting said signal-disrupting structure to said card for said substantially linear motion with respect to said antenna.

22. A method of reducing the likelihood of unauthorized access to a proximity communication apparatus while permitting appropriate access, said method comprising the steps of:
maintaining said apparatus in a first state wherein a signal-disrupting structure is positioned to substantially disrupt radio frequency (RF) communication with said apparatus, said signal-disrupting structure being formed from a material exhibiting low magnetic permeability; and
transitioning said apparatus to a second state when RF communication is desired, said signal-disrupting structure being moved, in said second state, such that RF communication can proceed in a substantially unimpeded manner.

23. The method of claim 22, wherein said signal disrupting structure is generally planar, said apparatus comprises an antenna, said antenna has first and second major sides, and said signal disrupting structure is substantially adjacent only a single one of said first and second major sides of said antenna in said first state.

24. The method of claim 23, wherein said signal disrupting structure substantially covers said single one of said first and second major sides of said antenna in said first state.

25. The method of claim 24, wherein said signal-disrupting structure is at least partially formed from a conductive material.

26. The method of claim 25, wherein said signal-disrupting structure is moved in a substantially rotary manner with respect to said antenna.

27. The method of claim 25, wherein said signal-disrupting structure is moved in a substantially linear manner with respect to said antenna.

28. A contactless proximity communication apparatus comprising:
a body portion, said body portion in turn comprising:
a body;
a communications circuit associated with said body; and
an antenna electrically coupled to said communications circuit; and
a signal-disrupting portion mounted for motion with respect to said body portion, said signal-disrupting portion being configured to substantially disrupt RF signals associated with said antenna in a first position and to permit substantially unimpeded passage of the RF signals associated with said antenna in a second position, wherein said signal disrupting portion is generally planar, said antenna has first and second major sides, and said signal disrupting portion is substantially adjacent only a single one of said first and second major sides of said antenna in said first position.

29. The apparatus of claim 28, wherein said signal disrupting portion substantially covers said single one of said first and second major sides of said antenna in said first position.

30. The apparatus of claim 29, wherein said signal-disrupting portion is at least partially formed from a conductive material.

31. The apparatus of claim 30, wherein said conductive material is metallic.

32. The apparatus of claim 30, wherein said motion is substantially rotary motion, further comprising a hinge, said hinge mounting said signal-disrupting portion for said substantially rotary motion with respect to said antenna.

33. The apparatus of claim 32, wherein said body is in the form of a card, said card defining a keyhole-shaped region adapted for releasable retention of said hinge.

34. The apparatus of claim 30, wherein said motion is substantially linear motion, further comprising a track formed on one of said body portion and said signal-disrupting portion, said track mounting said signal-disrupting portion for said substantially linear motion with respect to said antenna.

35. A kit of parts adapted for use with an RF payment card comprising an antenna having first and second major sides, said kit comprising:
a signal-disrupting structure having a conductive portion adapted to substantially disrupt radio frequency (RF) signals when in a first position relative to the antenna and to permit substantially unimpeded passage of the RF signals when in a second position relative to the antenna; and
a mounting portion securable to said signal-disrupting structure;
wherein said signal disrupting structure is configured to be substantially adjacent only a single one of said first and second major sides of said antenna in said first position.

36. The kit of parts of claim 35, wherein said signal disrupting structure is configured to substantially cover said single one of said first and second major sides of said antenna in said first position.

37. The kit of parts of claim 36, further comprising an instruction sheet providing instructions for assembling said signal-disrupting structure to the payment card with said mounting portion such that said signal-disrupting structure will be mounted for motion with respect to the payment card upon assembly thereto.

38. The kit of parts of claim 37, wherein said motion is substantially rotary, further comprising the RF payment card, wherein said mounting portion comprises a hinge.

39. The kit of parts of claim 38, wherein said motion is substantially linear, further comprising the RF payment card, wherein said mounting portion comprises one of:
a track formed on said signal-disrupting structure for receipt of said card; and
a track-engaging portion formed on said signal-disrupting structure so as to engage a track of said card;
said mounting portion mounting said signal-disrupting portion to said card for said substantially linear motion with respect to said antenna.

40. A method of reducing the likelihood of unauthorized access to a proximity communication apparatus while permitting appropriate access, said method comprising the steps of:
maintaining said apparatus in a first state wherein a signal-disrupting structure is positioned to substantially disrupt radio frequency (RF) communication with said apparatus; and
transitioning said apparatus to a second state when RF communication is desired, said signal-disrupting structure being moved, in said second state, such that RF communication can proceed in a substantially unimpeded manner;
wherein said signal disrupting structure is generally planar, said apparatus comprises an antenna, said antenna has first and second major sides, and said signal disrupting structure is substantially adjacent only a single one of said first and second major sides of said antenna in said first state.

41. The method of claim 40, wherein said signal disrupting structure substantially covers said single one of said first and second major sides of said antenna in said first state.

42. The method of claim 41, wherein said signal-disrupting portion is at least partially formed from a conductive material.

43. The method of claim 42, wherein said signal-disrupting structure is moved in a substantially rotary manner with respect to said antenna.

44. The method of claim 42, wherein said signal-disrupting structure is moved in a substantially linear manner with respect to said antenna.

45. A contactless proximity communication apparatus comprising:
a body portion, said body portion in turn comprising:
a body defining a keyhole-shaped region;
a communications circuit associated with said body; and
an antenna electrically coupled to said communications circuit;
a signal-disrupting portion configured to substantially disrupt RF signals associated with said antenna in a first position and to permit substantially unimpeded passage of the RF signals associated with said antenna in a second position; and
a hinge, said keyhole-shaped region being adapted for releasable retention of said hinge, said hinge mounting said signal-disrupting portion for said substantially rotary motion with respect to said body portion between said first and second positions.

46. A kit of parts adapted for use with an RF payment card comprising an antenna having first and second major sides and a body defining a keyhole-shaped region, said kit comprising:
a signal-disrupting structure having a conductive portion adapted to substantially disrupt radio frequency (RF) signals when in a first position relative to the antenna and to permit substantially unimpeded passage of the RF signals when in a second position relative to the antenna; and
a hinge portion securable to said signal-disrupting structure and configured to snap into the keyhole-shaped region of the card.

47. The kit of parts of claim 46, further comprising an instruction sheet providing instructions for assembling said signal-disrupting structure to the payment card with said hinge portion such that said signal-disrupting structure will be mounted for substantially rotary motion with respect to the antenna upon assembly thereto by snapping said hinge into the keyhole-shaped region of the card.

48. The kit of parts of claim 47, further comprising the RF payment card having:
a body, said body defining the keyhole-shaped region;
a communications circuit associated with said body; and
the antenna having the first and second major sides and electrically coupled to said communications circuit;
wherein said hinge portion is adapted to snap into said keyhole-shaped region and to secure said RF payment card to said signal-disrupting structure such that said antenna and said structure are capable of said substantially rotary motion between said first position and said second position.

49. A kit of parts adapted for use with a wallet and an RF payment card comprising an antenna having first and second major sides, said kit comprising:
a signal-disrupting structure having a conductive portion adapted to substantially disrupt radio frequency (RF) signals when in a first position relative to the antenna and to permit substantially unimpeded passage of the RF signals when in a second position relative to the antenna, said first position being collocated with the card in the wallet, said second position being in the wallet with the card moved away from the wallet; wherein said signal disrupting portion is configured to be substantially adjacent only a single one of said first and second major sides of said antenna in said first position; and
an instruction sheet providing instructions for collocating said signal-disrupting structure in the wallet with the card when protection from communication is desired and for removing the card from the wallet while leaving said signal-disrupting structure in the wallet when communication is desired.

50. The kit of parts of claim 49, further comprising the RF payment card comprising the antenna having the first and second major sides.

51. The kit of parts of claim 49, wherein said signal-disrupting structure is formed from a material exhibiting low magnetic permeability.

52. The kit of parts of claim 51, wherein said material is metallic.

53. The kit of parts of claim 49, wherein said signal-disrupting portion and the card have substantially similar form factors.

54. A method of reducing the likelihood of unauthorized access to a proximity communication apparatus while permitting appropriate access, said method comprising the steps of:
maintaining said apparatus in a wallet adjacent a signal-disrupting structure that is positioned to substantially disrupt radio frequency (RF) communication with said apparatus; and
removing said apparatus from said wallet when RF communication is desired, while leaving said signal-disrupting apparatus therein, such that RF communication can proceed in a substantially unimpeded manner;
wherein said signal disrupting portion is generally planar, said apparatus comprises an antenna having first and second major sides, and said signal disrupting portion is substantially adjacent only a single one of said first and second major sides of said antenna in said wallet.

55. The method of claim 54, wherein said signal-disrupting portion is formed from a material exhibiting low magnetic permeability.

56. The method of claim 55, wherein said material is conductive.

57. The method of claim 56, wherein said material is metallic.

58. A system comprising:
a wallet;
an RF payment card comprising an antenna having first and second major sides; and
a signal-disrupting structure having a conductive portion adapted to substantially disrupt radio frequency (RF) signals when in a first position relative to the antenna and to permit substantially unimpeded passage of the RF signals when in a second position relative to the antenna, said first position being collocated with the card in the wallet, said second position being in the wallet with the card moved away from the wallet; wherein said signal disrupting portion is configured to be substantially adjacent only a single one of said first and second major sides of said antenna in said first position.
